(19) United States
(12) Patent Application Publication
(10) Pub. No.: US 2021/0194219 A1
(43) Pub. Date: Jun. 24, 2021

(54) Nuisance Current Blocker

(71) Applicant: Andrew Macdonald McAfee, Raleigh, NC (US)

(72) Inventor: Andrew Macdonald McAfee, Raleigh, NC (US)

(21) Appl. No.: 17/194,507

(22) Filed: Mar. 8, 2021

(51) Int. Cl. H01T 1/14; H01T 4/12; H01C 7/12; H01T 4/06

(52) U.S. Cl. CPC H01T 1/14; H01T 4/06; H01C 7/12; H01T 4/12

(57) ABSTRACT

The Nuisance Current Blocker (NCB) is a unique protective device that utilizes resistors, gas discharge tube arrestors and choke/inductors to block low level current on equipment grounding conductors while maintaining an effective ground fault path to quickly activate overcurrent protective devices. EPRI reported that 60% of the electric grid's primary return current travels back through the earth. The NEC addresses this “Objectionable Current” in Section 250.6 and provides options to remediate in (B)(3) with “Interrupt the continuity of the conductor . . . ” or (B)(4) “Take other suitable remedial and approved action” and also in 250.6(E). Residential grounding systems have no protection against primary return current. The NCB blocks this ground current from entering the home via well pumps, also reduces ground loops, magnetic fields, chokes high frequencies, and reduces contact current exposures on grounding mats, sheets, and RF shielding paint to prevent, according to the EPRI, potential cancer causing environments.

### FIELD OF THE DISCLOSURE

The device, called a Nuisance Current Blocker (NCB), is designed to block ground current from entering residential equipment grounding conductors yet enable a breaker to trip in fault conditions. It was inspired to help the electrically sensitive community and to be utilized by Building Biologists and electricians.

In 1998, to investigate why children were getting cancer from power lines, a National Institute of Environmental Health Sciences Working Group concluded that “internal electric field strengths greater than approximately 1 mV/m . . . in numerous well-programmed studies have shown strong effects . . . associated with carcinogenic agents.” In 2000, the Electrical Power Research Institute (EPRI) publishes research regarding the possible sources and levels of current that would create this internal 1 mV/m voltage field gradient in tissue. EPRI originally investigated power line magnetic fields as a possible causative factor in childhood leukemia but found that actual physical contact with current (contact current) is a much stronger damaging source than are magnetic fields. In 2002, they published Contact Voltage Measured in Residences: Implications to the Association Between Magnetic Fields and Childhood Leukemia where they updated their previous contact current findings from 18 μA, to new information saying “ . . . as little as 1 μA contact current exceeds this 1 mV/m benchmark.” [onlinelibrary.wiley.com/doi/abs/10.1002/bem.10038]

1 μA (micro-amp) is one millionth of an amp. 1 mA (milli-amp) is one thousandth of an amp and generally considered the perception threshold utilized by various standards. The most sensitive devices we have readily available to protect humans against fault conditions require a minimum of 5 mA and that is a GFCI (ground fault circuit interrupter). A GFCI only measures the imbalance between the neutral and hot wires and just assumes the 5 mA is on the equipment grounding conductor.

There are no devices testing or sensing the grounding conductor directly for current that comes from outside the home breaker panel. Even current on the equipment grounding conductor sourced from inside the home breaker panel (15 A breaker) requires at least 90-150 amps to trip in less than one second. 150 A is a long way from 1 μA. [See mikeholt.com/technical-grounding-Ground-Rod-Does-Not-Assist-in-Clearing-a-Fault-(01-25-2K).php.]

EPRI reported in Identifying, Diagnosing, and Resolving Residential Shocking Incidents, Final Report, September 1999, TR-113566, that “60 percent of the neutral return current from a multigrounded neutral electrical distribution system returns to the source substation through and/or over the earth.” [Death by Grounding by Donald Zipse. ieeexplore.ieee.org/document/4663964]

This neutral return current is largely sourced from the primary side of the transformer, the distribution high voltage side, which creates a circuit between the transformer back to the substation. This ubiquitous source of “foreign”, “stray” or “NEV” current in the ground, from multigrounded neutral grid system is a significant contributor of current on grounding conductors in our homes. The secondary side, the lower voltage residential feed, connects the transformer's service neutral to the home grounding system. The primary return and secondary neutral are connected, bonded together at the transformer. This brings primary return current into the home grounding system.

The NESC requires the transformer's neutral to be connected to earth (grounded) at the transformer. And the NEC requires the neutral to be grounded at the home's service entrance panel, a second connection to earth. The home's equipment-grounding conductor, which connects to the neutral/grounded conductor at the service, is connected to every metallic appliance frame, pipe and metallic structure likely to be energized in the home. Then there are grounded appliances like a well pump, which creates another path to earth through its casing, and is a “third parallel path contributing to the flow of hazardous uncontrolled electric current over earth.” [Dangers of Stray Voltage and Current by Donald Zipse]

EPRI found that one of the largest sources of current coming into the home, exists on metallic water pipes that interconnect the electrical service equipment between residences. The reason water pipes are connected to the service is related to the power company's desire to preserve their transformers from excessive fatigue.

Forensic Electrical Engineer Donald Zipse wrote in his paper The Hazardous Multigrounded Neutral Distribution System and Dangerous Stray Currents that the “The utility has usurped Mr. Customer's internal wiring system for the enhancement of their [utility] electrical system in order to reduce the utility's costs for the benefit of the transformer.” [ieeexplore.ieee.org/document/1242596]

Triplen Harmonics

The electrical grid has been overwhelmed with nonlinear loads which create triplen harmonics and higher frequencies that add together on the neutral which can then end up carrying more current than the 3 phase conductors. This overloaded grounded conductor then pushes even more current into the earth and into home grounding systems, along with the harmonics and higher frequencies as well.

The following is an excerpt from a published report by Stetzer, Leavitt, Goeke and Havas called Monitoring and remediation of on-farm and off-farm ground current measured as step potential on a Wisconsin dairy farm: A case study: ‘Because of the increased and high-frequency currents on the utilities' primary neutral, the electric utilities decided to use the earth as a return path to their substations for the excess currents they are responsible for. Once the currents are in the earth, they flow uncontrolled over the surface, across private property, into homes and barns, and through humans and animals. This was done despite national standards and electrical safety codes, as evidenced in the IEEE's National Electrical Safety Code (1996) book under Rule 92D, which states, “Ground connection points shall be arranged so that under normal circumstances there will be no objectionable flow of current over the grounding conductor.”’[doi.org/10.3109/15368378.2015.1089888]

Neutral Isolators

There are devices available to the gas and the electrical utility companies that address this problematic primary to secondary side transformer connection and the larger multigrounded neutral grid system that results in the hazardous conditions knows as Neutral-to-Earth Voltage (NEV), nuisance shock, and stray voltage and stray current.

In response to the needs of dairy farmers to preserve their cow's health and milk production, there are devices available that can both block DC and AC current under day-to-day conditions and then under fault conditions, provide low impedance connections. This provides isolation between the primary and secondary neutrals at the transformer, but reconnect the two systems during an electrical fault, to limit the voltage between the two systems. By effectively isolating these two systems, neutral-to-earth voltage or stray voltage/current is reduced or eliminated on the customer's service.

One such device is the Ronk Blocker (Stray Voltage Isolator) [ronkelectrical.com/products?sort_by=sku&categories[ ]=1703&category=blocker-stray-voltage-isolator].

Another such device is the Dairyland Variable Threshold Neutral Isolator (VTNI) [dairyland.com/images/pdf/datasheets/VTNI_DataSheet_200020.pdf]

The Ronk differs in that it uses a magnetic core saturating reactor, has approximately 2000 ohms resistance at 6 volts and has 2 models that activate at either 11 or 22 VAC.

The Dairyland VTNI has 5000 Ohms between contacts and the shorted mode starts at 45 VAC peak.

The Dairyland model VTNI also comes with a warning that it is not authorized for use in solving nuisance shock to persons at swimming pools or similar human health situations where structure to ground voltage is present.

There is an increasing demand by the electrically sensitive community to remove the current from their grounding conductors and the harmonic “noise” from their residential wiring premises. These two devices above are not designed to be used in residential applications.

Eliminating all current from home wiring systems will also eliminate its associated magnetic fields, the grid's triplen harmonics and higher frequencies labeled as electromagnetic interference (EMI) and/or dirty electricity (DE) which will help reduce damage to equipment as well as to animals and humans. Removing contact current from the grounded frames and surfaces of appliances and bath fixtures in the home is of the highest priority to reduce what EPRI found may be the greatest contributor to cancer causing environments.

After removing the home's wiring code violations, the remaining ground current, largely from grid sourced primary return current, becomes a National Electrical Code (NEC) 250.6 “objectionable” current violation. The 2017 NEC Section 250.6 requires the wiring to have an . . . . “(A) Arrangement to Prevent Objectionable Current. The grounding of electrical systems, circuit conductors, . . . and conductive normally non-current carrying metal parts of equipment, shall be installed and arranged in a matter that will prevent objectionable current.” If there is current, there are allowed “(B) Alterations to Stop Objectionable Current. 1) Discontinue one or more but not all of such grounding connections. 2) Change the locations of the grounding connections. 3) Interrupt the continuity of the conductor or conductive path causing the objectionable current. 4) Take other suitable remedial and approved action.”

Section 250.6(B)(3-4) provides ample support for the introduction and use of the NCB to stop “objectionable current.”

A certified decoupler can comply and meet code requirements. This is specifically authorized in the National Electrical Code (NEC) section 250.6(E) if meeting or exceeding effective ground-fault current path requirements.

The NCB is designed for residential applications to activate overcurrent protection devices (breakers) in a fault condition, preserving the most essential function of the equipment grounding conductor, safety. Without the NCB, the equipment grounding conductor is a vulnerable path for primary return current to enter and contaminate all the home's grounded devices creating electromagnetic fields filled with the grid harmonics.

Therapeutic Grounding

Some health coaches are recommending grounding products or therapies that make direct contact with grounded objects, mats, sheets, pads, devices and surfaces. Grounded shielding paint is also being employed to block sources of radiofrequency radiation.

The grounding myth is addressed by Elliot Rappaport in Does Grounding Make a System Safe? “It has been shown in the examples cited for faults within equipment that the act of grounding does not make systems safer. In fact, the idea that grounding minimizes the hazardous voltage due to an enclosure fault is a myth. The voltage at the faulted enclosure, and any metallic enclosure connected to it, will be raised to 50-88% of the supply voltage [even] if the minimum requirements of the NEC are utilized.” [ieeexplore.ieee.org/document/6682612]

What this above quote shows is that to be attached to the equipment grounding conductor (“grounded”) is not an inherently safe thing to do. It also carries the “noise” and dirty electricity from the immediate appliances and larger electrical grid. Some health advocates have realized this exposure problem and have created grounding cords that include resistors inside the cord to reduce or eliminate current flow to the therapeutic grounding device. They recognize the ubiquitous nature of current on the grounding system and how harmful it may be, including the dirty electricity (DE). But without providing a means to turn off the current, trip the circuit breaker that may be energizing the grounded item in a fault condition, serious harm may come to whomever is touching that grounding mat, bed sheet, etc.

Because the perception threshold of most people is 1 mA, this topic has been largely ignored, except by the Dairy Industry. Now that electrically sensitive (ES) persons can feel this NEV/Stray Current, far below the generally accepted 1 mA threshold, it is ES persons that are often recognized as the problem. PGE (Pacific Gas and Electric) of CA exemplifies a power company's response with this quote, “Because stray voltage is normally related to very low voltage and current, it sometimes is not detectable and therefore not a problem.” [pge.comAncludes/docs/pdfs/about/news/outagestatus/powerquality/power_quality_bulletin-issue_no.2_stray_volt.pdf]

The perception level of 1 mA equates to the reasoning, if people don't feel it, it isn't a problem. Therefore, the existing electrical standards are not applicable as health standards. The existing fire code and especially the equipotential plane/bonding system concept, based upon creating a metallic grid of similar voltages, is not enough to establish a day-to-day protected environment for humans. [Equipotential Planes, a Figment of the Imagination. Copyright Material IEEE Paper No. ICPS-06 by Donald Zipse]

Using voltage as the testing standard for equipotential grid systems is inaccurate and will not adequately measure a hazardous flow of current throughout the grounding systems. Only during a fault or very brief lightning strike condition will voltage measurements become relevant but in all other 24/7/265 conditions, will lead to a false sense of security. Since the standards exist to preserve the utility's multigrounded neutral system, the entire model needs to be reconstructed to serve an entirely different goal, human health, not transformer health.

Current is what kills. Voltage is merely a shadow of its potential. A new electro-medical standard is required, built upon an entirely new target, less than 2 μA of contact current, from any source on any contact surface. In the meantime, devices like the NCB that stops current on grounding systems, is the best immediate action to stop further injury, while we wait for the electrical grid and national health standards to change.

Donald Zipse: “With the amount of stray current flowing uncontrolled over the earth and flowing over other electrically conductive paths, it is only a matter of time until electrical injuries increase to an unacceptable level. When the public becomes educated and made aware of the dangers and hazards associated with uncontrolled flow of stray current, it is hoped that a public clamor of protest will arise and action taken to rectified the situation.” [ieeexplore.ieee.org/document/4663964]

Vocabulary. This application uses a set of terms and definitions set forth in the following definitions.

AC: Alternating Current or Air Conditioning, depending upon the context.

Amperage: (Amp or A) is the measurement of current flow. 1 Amp consists of 1000 mA (milli-amps). 1 mA consists of 1000 μA (micro-amps). 1 mA is generally considered the contact current perception threshold.

Circuit breaker: A device designed to open and close a circuit automatically on a predetermined overcurrent without damage to itself when properly applied within its rating. To trip in less than 1 second, fast activating mechanisms require at least 6-10 times the rating of the breaker (15 A breaker=90-150 A fault current).

Contact current: When a person touches conductive surfaces at different potential's and completes a path through which electric current flows within the body.

Dirty electricity (DE): Anything other than 60 Hz AC. Switch mode power supplies often will add frequencies anywhere from 15 to 90 kHz to the AC sine wave. Triplen harmonics occur anywhere from 180 to 3 kHz. Any digital component will add some type of distortion, or other line disturbance that compromises the efficiency of appliances. DE has been shown to cause numerous health effects including blood sugar spikes, depression, mood swings, increased shaking associated neurological diseases and many other symptoms.

Effective Ground-Fault Current Path: An intentionally constructed, low impedance electrically conductive path designed and intended to carry current in ground-fault conditions from the point of a ground fault on a wiring system to the electrical supply source to quickly activate the overcurrent protective device.

Electro-sensitivity (ES): Also electro-sentience and electro-hypersensitivity (EHS). Those that feel the presence of electromagnetic fields and its associated radiated energy.

EMI: Electro-Magnetic Interference. A term used primarily by the electronics industry describing the negative effects of electromagnetic fields, including radio waves that propagate through the air and is coupled onto other devices, conductors, components or equipment, resulting in a malfunctioning or interference upon equipment.

EPRI: Electric Power Research Institute, funded by and for the electrical industry in 1973, it is an independent research and development organization and a collaborative resource for the electrical industry that addresses it's technical and operational challenges.

Foreign current: Not locally sourced. “Foreign” current indicates current that cannot be controlled or shut off by a circuit breaker at the home. Sourced from another home sharing the secondary side transformer circuit or from the grid as primary side transformer return current.

Ground: The earth. Also a casual term for the equipment grounding conductor that attaches to the frame of appliances. It is commonly called the “ground” as it does connect to the earth at one point in the wiring premises. It should never carry current or have a voltage, but does on a regular basis. It is a mistake to believe grounding makes things safe. Current flows through the ground back to source, but not TO ground. The earth/ground is not considered an effective ground-fault current path to effectively clear a fault by tripping a breaker [See NEC 250.4(A)(5) “The earth shall not be considered as an effective ground-fault current path.” ].

Grounded: Common parlance for an appliance frame attached to an equipment grounding conductor hence becoming a grounded appliance. Grounded literally means something attached to the earth but this is where the confusion starts. See Ground. You don't want to connect an appliance to the earth if you want the overcurrent protection device (breaker) to work (trip) effectively. The Neutral/Grounded Conductor is required by code to connect to the earth, or be grounded, only once per wiring premises, at the main disconnect, to help the transformer. The Grounded Conductor (white wire) if connected to equipment grounding conductors on the load side of the main disconnect, is a code violation and is a major source of current on grounding conductors in a residence. The equipment grounding conductor being used to carry 120V return current for an appliance (240V AC unit subpanels) is another common source and code violation.

Grounded conductor: a system or circuit conductor that is intentionally grounded. The white wire the returns 120V current in residential wiring, casually called the neutral.

Ground fault. When a current carrying conductor, either the hot or neutral, accidentally touches the metal frame of an appliance or the earth. The equipment grounding conductor (the ground wire) should be the only low impedance path for current in order to effectively activate the overcurrent protection device.

Ground fault current: Continuous current, resulting from any phase conductor coming into contact with a grounded conductor or grounded equipment or to earth, or as the result of a neutral-to-ground fault.

GFCI: Ground-Fault Circuit Interrupter. A device intended for the protection of personnel that functions to de-energize a circuit or portion thereof within an established period of time when a current to ground exceeds the values established for a Class A device. Informational note: Class A ground-fault circuit interrupters trip when the current to ground is 6 mA or higher and do not trip when the current to ground is less than 4 mA.

Grounding Conductor, Equipment (EGC). The conductive path(s) that provides an effective ground-fault current path and connects normally non-current-carrying metal parts of equipment together to the system grounded conductor or to the grounding electrode conductor, or both.

Grounding Electrode Conductor (GEC): The 6 or 4 AWG bare copper wire that connects the ground rod (grounding electrode) up to the home's service neutral, and equipment grounding conductor system. There is only one GEC, from the neutral to earth at the service.

Harmonics: Harmonics are higher frequency waveforms superimposed onto the fundamental frequency which will distort its wave form/shape and diminishes the efficiency (power factor) of motors, conductors, especially the neutral, and subsequently adds more current into the earth. They are often multiples of the 60 Hz fundamental, but not exclusively.

Hot wire: The phase conductor. The wire/conductor (typically with black colored insulation) that brings the 120V electricity to the appliance or device. It is called hot because it has a dangerous voltage on it under normal conditions.

IEEE: Institute of Electrical and Electronics Engineers is a professional association with objectives towards educational and technical advancement, publishes tutorials and standards that are produced by its standardization committees.

Leakage current: Current flowing to or on the grounding conductor. Leakage current in equipment flows when an unintentional electrical connection occurs between the grounding conductor and an energized part or conductor. “Leakage current most commonly flows in the insulation surrounding conductors and in the filters protecting electronic equipment around the home or office. In extreme cases, it can cause a rise in voltage on accessible conductive parts.” [fluke.com/en-us/learn/blog/insulation-testers/controlling-leakage-current]

Multigrounded Neutral Distribution System: The neutral/grounded conductor plugged into the earth at every home and commercial service, transformer and at least 4 times per mile on transmission and distribution grid lines. This uses the earth as a return current path to reduce the voltage impact on transformers and line workers.

NEC: National Electrical Code. The NEC is a regionally adoptable standard for the safe installation of residential, commercial, and industrial building electrical wiring and equipment, and is adopted by states and municipalities in an effort to standardize their enforcement of safe electrical practices. The manual is published as a part of the National Fire Protection Association (an international nonprofit organization), and approved by the American National Standards Institute (ANSI) and formally identified as ANSI/NFPA 70, is the main reference code for electricians and insurance companies. But, state and local electrical inspectors are the “authority having jurisdiction” and supersede over the NEC.

NESC: National Electrical Safety Code. The code body for the electric power utility companies, published by the IEEE, a professional organization.

Neutral: In residential wiring, the wire/conductor with white colored insulation, that completes a 120V circuit from an appliance back to the electrical panel, is commonly called the Neutral but is technically the grounded conductor, as it is connected to the earth at the service equipment (main breaker). The Service Neutral is connected between the main panel back to the neutral point on the transformer, the source of voltage for the wiring premises, a system that is intended to carry current under normal conditions. It is unfortunate that the power companies in North America have grounded the Neutral as that is most often the foundational cause of current on grounding systems.

NEV: Neutral-to-Earth Voltage (See Stray Voltage). A grid related voltage measured between the neutral conductor or an extension of the neutral conductor (e.g., primary or secondary grounded conductor, bonded metallic water pipe, home grounding conductors) and remote earth. It is an aspect of the grid's primary return current. NEV-related issues range from nuisance shocking concerns at swimming pools, hot tubs and water faucets to outdoor showers, boat docks and animal contact points. Along with the traditional power frequency related (50/60 Hz) NEV, other line-connected equipment such as power line carrier-based communications devices as well as harmonic-generating variable speed drives, personal computers, and residential appliances, have been found to contribute to elevated NEV and subsequent contact voltage potentials.” [Guide to Understanding, Diagnosing, and Mitigating Stray and Contact Voltage. IEEE Std 1695-2016]

Nonlinear devices: Electrical devices that do not respond linearly, or predictably with a change in variables like resistance, capacitance, or inductance. Nonlinear loads, such as switch mode power supplies used in mobile phone chargers and computer power supplies, generate a multitude of harmonics in the power system, some of which are the 3rd harmonic. On three-phase systems, triplen harmonics (multiples of the 3rd harmonic) are of particular concern because they add together in the neutral conductor and can significantly increase the amount of neutral return current. [Guide to Understanding, Diagnosing, and Mitigating Stray and Contact Voltage. IEEE Std 1695-2016]

Nuisance Current Blocker (NCB): The NCB is a protective device that blocks low level current yet allows fault level voltages to pass in order to quickly activate an overcurrent protection device/circuit interrupter/breaker. The term “nuisance tripping” was coined by electricians when they couldn't figure out why and how current was getting onto grounding conductors and tripping breakers off. This nuisance current has fostered some commercially available devices for large industry to monitor grounding conductor leakage current levels and develop high-impedance grounded neutral systems. The Nuisance Current Blocker (NCB) stops common low level leakage current existing far below the threshold that a common overcurrent protection device would activate. Since the industry has established a very high threshold at which breakers will trip (due to annoying service calls where they couldn't find the reason for the breaker tripping) a very unhealthy and hazardous condition now exists.

Phase conductors: the current carrying ungrounded conductors commonly called the “hot” wires.

Primary return current: Regarding the distribution system of the electrical grid, he high-voltage primary side circuit is from the transformer back to the substation. The secondary side is from the transformer to the Service entrance equipment on residences or commercial settings. The high-voltage side of the transformer (primary side) is directly connected in Wye connected transfers to the secondary side of the transformer through the neutral point, which is commonly the 240 V residential side. Even with all the breakers off to a home or commercial wiring promises, there is still current circulating from the transformer's neutral, through the earth, back to the substation. Opening the low impedance connection between the primary and secondary neutrals effectively removes the primary neutral contribution to stray voltage. This is mostly done on dairy farms with a Neutral Blocker or Isolator like the Ronk Blocker Stray Voltage Isolator.

RF: Radio Frequency is considered energy oscillating from 3 kHz to 300 GHz which travels some distance through space. The FCC has allocated radio frequency bands between 9 kHz and 275 GHz and includes the microwave frequencies (300 MHz to 300 GHz).

Ronk Blocker: a neutral isolation device, is placed in the interconnection of the primary and secondary neutral, of the distribution transformer. Off-site stray, or neutral-to-earth voltage (NEV), can result from primary neutral currents, off-site faults, or marginal groundings. Ronk BLOCKER is designed to reduce the off-site contributions to the stray voltage, allowing the utility to focus on the on-site sources. The device operates directly on the principle of magnetic saturation. BLOCKER has a very low impedance (less than 0.5 Ohms) for a voltage level above 12 V but 2000 ohms for 6 V. This provides the fault current path in the event of a primary to secondary short in the distribution transformer (with a 7,200 V primary, the voltage drop of 12 V across the BLOCKER is less than 0.2%). If the utility cannot meet the 1 mA (one milliamp criteria), a neutral isolator can be installed for 90 days to address the problem. A waiver is required for more than 90 days. If a utility meets the 1 mA criteria, the farmer can request an isolator at his expense and leave it installed, but only if farm wiring meets code. [ronkelectrical.com/categories/blocker-stray-voltage-isolator]

Service neutral: The service entrance grounded conductor that connects the neutral point of the transformer, where it is grounded, to the main disconnect, at the Service (main disconnect), where it is grounded, again.

Stray voltage or Stray current: Also called Neutral-to-Earth Voltage (N-E-V) or primary return current. When these ground-based currents are present, animals or persons that contact grounded equipment such as metal stanchions or metal fence posts, will receive a shock as the electricity passes through their bodies. [tri-countyrec.com/content/stray-voltage] Due to the common grounding of the utility system and the customer electrical system, any neutral-to-earth voltage (NEV) on the utility system can be transferred to any grounded object in a building, such as metal water pipes. Other possible sources of NEV can be another utility such as the phone, cable, pipe line, or any combination of the above. Load, leakage, and fault currents flowing through the impedances of the neutral or grounding conductors to earth, produce NEV. There are multiple paths from neutral or grounding system to earth such as ground rods, metallic water lines, or other ground electrodes like well pumps. This means that there is always voltage to earth. Any metallic structure connected to the grounding system will also be at the same NEV. “So, the question is not if there is stray voltage, but what is the safe level.” [pge.comAncludes/docs/pdfs/about/news/outagestatus/powerquality/power_quality_bulletin-issue_no.2_stray_volt.pdf]

Transformer: Transforms a higher voltage to a lower voltage, usually down to 240V for residential service applications. A transformer supplying a three-wire distribution system has a single-phase input (primary) winding. The Wye transformer output (secondary) winding is center-tapped and the center tap connected to a grounded neutral.

Triplen harmonics: Triplens are multiples of the third harmonic (3rd, 6th, 9th, or 3×60=180 Hz, 6×60=360 Hz, 9×60=540 Hz . . . ). These specific harmonics created by nonlinear components, in an unbalanced three phase system, add together on the neutral and often results in more current on the neutral than the phase conductors. This overload reduces the neutral's ability to conduct electricity, overheats transformers and forces more current into the earth.

μA: micro-amps. See Amperage.

VAC: Volts Alternating Current

Voltage: A measurement of pressure between two points, an object and a reference point, and represents the potential for how much current will flow, depending upon impedance.

### SUMMARY OF THE DISCLOSURE

The basic model NCB is comprised of a resistor 104 or set of resistors and a gas discharge tube arrestor (GDT 105, 205, 305) or a parallel assembly of GDTs. This provides resistance to current flow on the applied equipment grounding conductor adequate to handle what is typically found in residential applications. Resistance options typically range from 1000 to 1 million ohms. This device can slowly drain away voltage charges on grounded mats and sheets over time should that medium become slightly energized by electric fields. In case of a fault, the GDT 105 parallel path is activated at various voltages (indoor 60-110 VAC), depending upon its application, to allow the quick trip activation of a breaker, to stop the fault current in that circuit. The NCB also has an embodiment as a filter and utilizes a 190 mH Nanocrystalline Common Mode Power Line Choke (choke/inductor) 103. This choke/inductor 103 helps block frequencies higher than 700 Hz and is especially effective above its cut-off frequency around 3 kHz.

It was originally designed to address dog fence frequencies that enter from the earth through the grounding electrode and in the home grounding system. In addition to these 3 basic components, choke/inductor 103, resistor 104, and GDT 105, various additional embodiments can include manual switches to alter the resistance, to turn on/off the NCB for testing purposes, an alarm/buzzer to alert the home owner of a surge, and an optional voltage readout and employ various adapters and fittings for different applications.

If the home is properly established with only one earth connection, one 4 or 6 AWG wire/grounding electrode conductor (GEC), connecting the Service Neutral down into the soil to a grounding electrode or ground rod, the grid's primary current, emerging from the earth will (mostly) take the path of least resistance, up the Service Neutral and back to the transformer. When there is more than one reference point to the earth, the primary return current will have a loop to travel possibly through the home, on the equipment grounding conductors. Two ground rods with only one grounding electrode conductor (GEC) up to the Service, will not create a loop. Two GEC's will create a loop for current to flow through the home. This increased current flow in the home raises the background electromagnetic field presence which includes all the frequencies (harmonics, dirty electricity, etc.) riding in on the current from the grid. To block this circulation of primary return current from entering the home through appliance equipment grounding conductors, the NCB is the most readily available option to home owners.

Individual inventive concepts can be implemented without implementing all details provided in a particular example. It is not necessary to provide examples of every possible combination of the inventive concepts provide below as one of skill in the art will recognize that inventive concepts illustrated in various examples can be combined together in order to address a specific application.

Other systems, methods, features and advantages of the disclosed teachings will be immediately apparent or will become apparent to one with skill in the art upon examination of the following figures and detailed description. It is intended that all such additional systems, methods, features and advantages be included within the scope of and be protected by the accompanying claims.

### BRIEF DESCRIPTION OF THE FIGURES

The disclosure can be understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 is the basic diagram with its most essential components, without switches or any additional add-on features.

FIG. 2 shows the placement of the NCB for in-door applications. It is showed in-series between a receptacle outlet 210 and a grounded bed sheet 211 or a grounding mat 212.

FIG. 3 describes the placement in-series between an outside grounded appliance, for instance well pump 321, and a main service disconnect panel 311 grounding bus bar 310.

### DETAILED DESCRIPTION

The presently disclosed subject matter is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Figures can allow various steps unless and except when the order of individual steps is explicitly described.

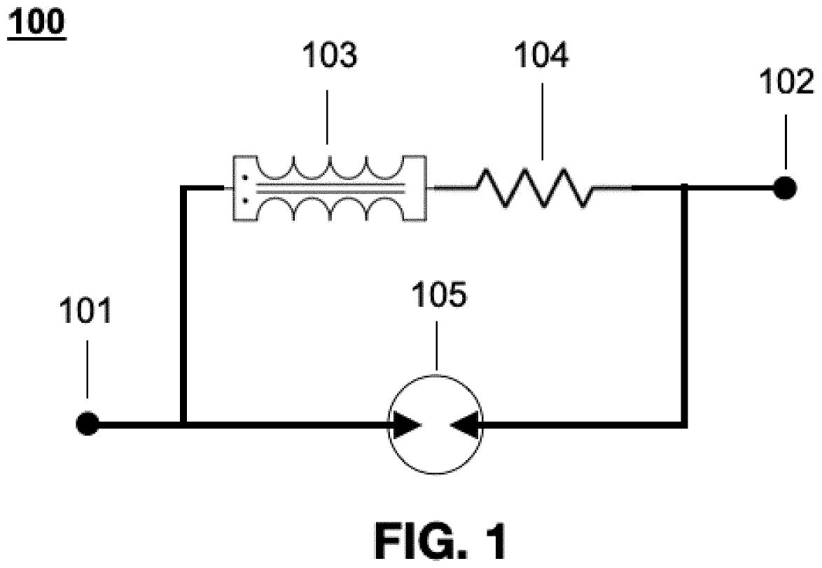

FIG. 1 is the core circuit diagram and embodiment of the protective apparatus before adding any embellishments or additional components to compliment the different applications. The choke/inductor is 103. Resistor 104 (or set of resistors) can be set from 1000-1,000,000 ohms. The GDT 105 (or pair of GDTs) will activate at about 60V, 120V or 470V, depending upon the application.

In FIG. 1, the unprotected path 101 will ideally be attached to incoming current and frequencies. The protected outgoing path 102 would be ideally connected to a protected device.

In FIG. 1, 60 Hz current entering the unprotected path 101 will meet at least 10,000,000 ohms of resistance from the GDT 105 and take the alternate path through the choke/inductor 103. Higher than 700 Hz frequencies will be increasingly trapped by 190 mH choke/inductor 103 as the cut-off zone is around 3 kHz. Those below 700 Hz, especially 60 Hz electricity of common households, will continue through to meet resistor 104. Depending upon the ohms of resistor 104, either no or only limited micro-amp levels of current will be allowed through to the protected side 102.

In FIG. 1, if voltages rise to more than 60V, indicating a ground fault, the GDT 105 path quickly activates to be a low impedance path for current. This is designed to quickly trip a breaker should the protected line 102 makes contact with a live wire. The best hope we have for fault protection and against electrocution is the fast acting trip design of a circuit breaker.

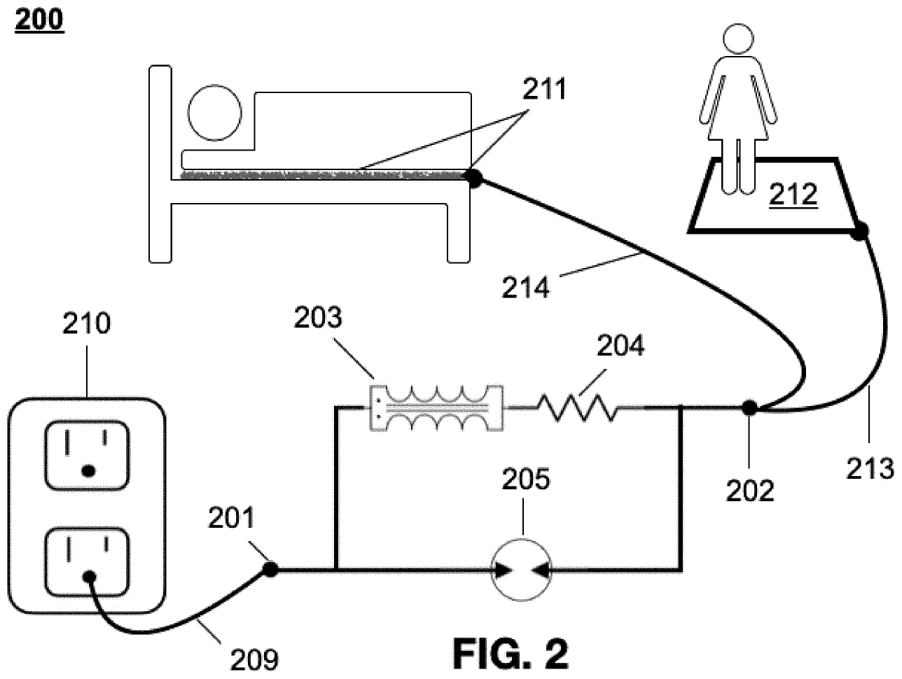

FIG. 2 shows an indoor embodiment to protect a person using a grounding mat 212 connected to 202, from the harmful nuisance current and frequencies entering in from the AC receptacle outlet 210. The NCB connects at 201 to a line 209 and plugs into receptacle outlet 210. The NCB also protects the grounding sheets 211 from the equipment grounding conductor current in outlet 210. Not pictured are the connectors, the box housing, or switches for testing purposes.

In FIG. 2, starting at the receptacle outlet 210, the unprotected line 209 which has low level current and DE frequencies, connects to the NCB's unprotected point 201. The current will then take the path of least resistance, towards the choke/inductor 203.

The GDT 205 has about 10 million ohms of resistance and resistor 204 has less, anywhere from 1000 to 1,000,000 ohms, depending upon the embodiment of the device. All current and frequencies below a certain level will be blocked from traveling on either path, by resistor 204 or GDT 205.

Frequencies will be absorbed by the choke/inductor 203 from oscillating, and depending on the current level, the milli-amp levels of current are blocked by both resistor 205 and the GDT 205. Should either the grounding sheets or mat come in contact with a live/energized source of phase current from that circuit, the GDT 205 will activate (at a certain fault level voltage like 60 VAC) and current will flow back through 201, 209 to 210 and back to trip the breaker (overcurrent protection device) and shut off the source energizing that circuit.

Variations include multiple GDT configured in parallel set for differing voltages, one to activate around 60 VAC and the other around 110 VAC. This provides additional resilience, security and longevity to the device and increases efficacy of the breaker under differing fault conditions.

A ground fault can happen from making direct contact with the 120 VAC phase conductor or from the neutral/grounded conductor, both are at least 60 VAC, as it makes a parallel path with the equipment grounding conductor. As there will never be an ideal condition of zero impedance on the fault return path, fault voltages will most likely be higher than 60 VAC, or half the phase voltage (typically between 115-120 VAC).

The GDT 205 is designed to trip a breaker, quickly.

Resistor 204, depending upon its rating, will allow electric fields that have built up a capacitive charge upon bodies, to dissipate slowly. This is a very key element to grounding mats as they were being sold to lower excessive body voltage.

Resistor 204 will not lower body voltage to zero as some existing grounding mats will do when tested with a body voltage meter or multimeter, to the equipment grounding conductor.

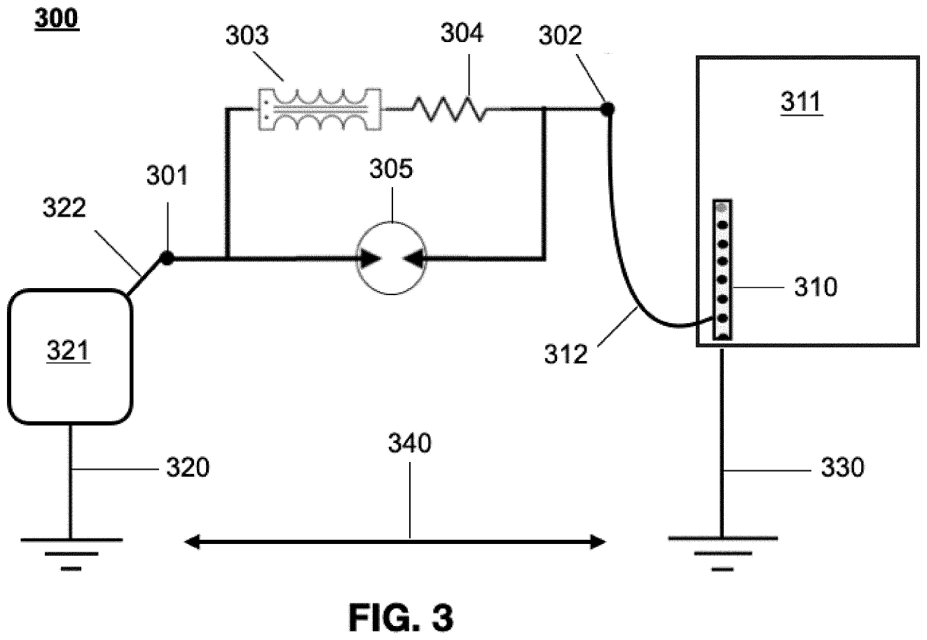

FIG. 3 addresses appliances 321 that make a direct connection to the earth 320, outside the home. This application is designed to stop earth current 340, existing from either primary return current or secondary side of the transformer sources. And we need to be protected from an open neutral condition or a fault from a neighbor's residence sharing the same transformer (secondary side transformer current). Anything plugged into the earth has the potential to be a conductor for these “foreign” current sources.

FIG. 3 shows the NCB installed in-series on the equipment grounding conductor 322 between a well pump 321, and main panel 311, terminated on bus bar 310, through equipment grounding conductor 312, as one example. The primary return current 340 will seek a path back to source on the grounded metallic components through 320 of the well 321, that are connected to the equipment grounding conductor 322, and travel into the home wiring through grounding bus bar 310, if the NCB were not applied to block it.

To interrupt the continuity of that circuit, as provided by NEC 250.6(B)(3), the NCB connects 301 to the equipment grounding conductor 322 of the outside appliance 321. The protected side 302 connects through conductor 312 to the panel equipment grounding bus bar 310, or neutral bus, depending upon the location of the appliance breaker.

One of skill in the art will appreciate that the choke/inductor 303 could alternatively be placed on the side of the unprotected source, and resistor 304 absorbing the resulting current and frequencies on the protected side, the home side, though, either direction (302 to 301) will work to block current.

Typical appliances that invite primary side transformer current into the home grounding system are: well pumps, basement sump pumps, flood drain grinders, circuits from underground bunkers, cable internet lines, and phone line bonds. The public has other readily available solutions to block the cable internet sheath current, water and gas pipe bond current and they should be utilized first.

Addressing appliances that have an equipment grounding conductor is the focus here, not their bonds. Equipment grounding conductors 209 or 312 facilitate clearing a fault quickly within a breaker panel 311, through the neutral/ground connection 310. Bonds between metallic objects serve purposes intended for lightning strike surges by creating an equipotential plane or to facilitate a path to earth. Unfortunately, bonds become a part of the problem as they create loops in the grounding system and adds a path the earth that delays the efficacy of an overcurrent device. The NCB can be effectively utilized to remove ground loops on bonding systems.

Blocking foreign current on the cable internet coax is best done with a ground loop isolator. The water and drain pipes can have PVC or food grade PEX inserted to interrupt their continuity. Gas lines can have dielectric unions inserted to stop that foreign current or loops.

To maintain the equipment grounding conductor's performance, the NCB can be installed in-series with the appliance, on the equipment grounding conductor, to stop the nuisance foreign current and loop current yet provide essential ground fault protection. The same for sump pumps, flood drain grinders or any metallic appliance making contact with the soil or concrete and rebar that brings in primary grid current flows to the home grounding system.

The question must be asked, does this bond only serve as a lightning path to earth or is it to trip a breaker? We don't want both as NEC 250.4(A)(5) clearly specifies: “The earth shall not be considered as an effective ground-fault current path.” The GDT should not allow lightning to enter a wiring premises, only leave to go to earth. Bonds and devices specifically for lightning should be rated for lightning, above 240V, or they will corrupt the home grounding system. Otherwise, we will have increased current on grounding conductors throughout the wiring premises.

Additional Components

One embodiment includes the use of a buzzer, an alarm indicating high voltage or current condition.

Another embodiment includes a switch to access resistor settings of different magnitudes.

Another embodiment includes a switch for different gas discharge tube voltage activation levels.

Another embodiment includes an on/off switch for the entire unit to quickly assess levels with and without an active NCB.

Another embodiment includes a voltage readout display.

Another embodiment includes Banana plug insert adapters to accommodate existing grounding mats and grounded bed sheet product lines.

Another embodiment includes alligator clips to adhere to a surface or conductor.

Another embodiment will be a master test box that has all of the components in one so a Building Biologist can carry one master NCB around to test all the variables, before and after, for each application.

Alternative Applications

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

Where methods and/or events described above indicate certain events and/or procedures occurring in a certain order, the ordering of certain events and/or procedures may be modified. Additionally, certain events and/or procedures may be performed concurrently in a parallel process when possible, as well as performed sequentially as described above.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

Phone Bonds

The bond wire from the phone line grounding bus is connected to the grounding electrode conductor. It is also connected back to the transformer's ground and neutral connection. It is prime source for lightning and grid surges to enter the home's grounding system. Home faults should not go to earth, or get dispersed in multiple paths throughout the neighborhood, so this phone bond requires a higher than 240V GDT, and suggest 470V. Lightning will surely have more than household fault current and voltages and it is beneficial to them separate.

Shielding Paint

If the home has had shielding paint installed and is being grounded to an outdoor, secondary or auxiliary grounding electrode, this raises an interesting dilemma. It is fairly easy to block foreign current sources. Those outside grounding connections are not associated with any indoor overcurrent protection devices. Just add resistance and diode of an adequate size to that line and that blocks the foreign current. But Radio Frequency (RF) shielding paint is in very close proximity to indoor circuits and wiring in the walls. The potential is high (nearly impossible to avoid) for the indoor electric fields to be attracted to the outside grounding path to return to source. The inverse is true as well. The exterior sources of primary current will find a way into the home to return to the substation. An area of capacitance will be created on and between the two systems, the outdoor secondary grounded shielding paint and the indoor grounded wiring in the walls. The resulting electric field and the frequencies contained therein is a problem.

The NEC says “electrically conductive materials” (and shielding paint is certainly electrically conductive) “shall be connected together . . . ” Section 250.4(A)(4): Bonding of Electrically Conducted Materials and Other Equipment. “Normally non-current carrying electrically conductive materials that are likely to become energized shall be connected together and to the electrical supply source in a manner that establishes an effective ground fault current path.”

The potential for lightning to arc from one material to the other is possible and can create a fire. Bonding them together limits the voltage difference between systems. So the NEC preferred choice reverts back to eliminating the outside auxiliary grounding electrode and merging the two systems into one, grounded in one place with the house electrical system. That brings up the problem of dirty electricity sourced from the home wiring and appliances being broadcast out from the surfaces of the shielding paint out into the sleeping area. Both are a predicament and have clear problems, either way. It is best to avoid this conundrum and use nonconductive, ungrounded RF shielding fabrics and turn the power off to the bedroom so there are no electric fields.

If this is not possible, adding the NCB to the grounding system of the shielding paint could more closely satisfy the spirit of the code requirements and additionally reduce the electric field/dirty electricity contamination of the shielded walls. Of course, the indoor sources of current and electric fields must be dealt with as much as possible, in either case. It is highly recommended (a rule) to de-energize the conductors inside the walls to limit the capacitive effects and inductive properties between the wiring and shielding paint. Next best is using Metal Clad (MC) cable or armored cable which does a good job of containing the indoor sources of electric fields if the home has been thoroughly mitigated of its electrical neutral/ground code violations. MC will not prevent a lightning surge arc between 2 separate grounding systems.

Eliminating Ground Loops Between Appliances and Panels

Another appliance based problem deals with small DC transformers grounded inside of AC units and air handlers. There is often 20-50 mA of current on the coolant line and the equipment grounding conductors associated with those systems. The handler or AC condenser unit DC transformer should not be electrically connected to the frame. In addition, often the AC unit will be powered from the main disconnect panel, outside where the neutral is earthed, and the coolant line is connected to the air handler, inside, powered from a subpanel. This creates a loop on the grounding system and the coolant line between the units. Short of moving the AC unit to the subpanel along with the Air handler, there is no solution for removing that current loop from the equipment grounding conductor. The NCB can be used to stop the circulation of current on that equipment grounding conductor/system yet preserve its fault clearing capabilities.

Diode to Keep Out Lightning Surges

Another embodiment of the NCB integrates a diode in series with the GDT and choke/inductor. Should lightning energy surge towards the home, the energy would travel out to the secondary grounding electrode and help dissipate the surge. Should lightning strike nearby on the property, the surge would be blocked and not travel up the grounding conductor into the shielding paint and into the home. There is no accommodation for a direct hit from lightning. The GDT voltage would be established above household voltages (470V) as to not interfere with proper functioning of the 120V or 240V circuit breakers. Too many paths on the grounding system delays or prevents the action of the overcurrent protective device and we certainly don't want the earth to be a part of the fault clearing process as NEC 250.4(A)(5) clearly specifies: “The earth shall not be considered as an effective ground-fault current path.”

Equipotential Grids and Swimming Pools

Swimming pools have large equipotential grid rebar systems that will bring in primary current from the earth and into the home through the pool subpanel equipment grounding conductor. The best way to remove the hazard is by removing all lights or appliances that make contact with the water or even come near to the water and cutting the wires that come to the pool lights to ensure they can never conduct electricity or will ever need a breaker for protection. Then all that is remaining is the pool equipment bonded to the equipotential pool grid. The NCB can then be used to stop the circulation of earth current between the outside grid and the pool equipment. The pool equipment needs to have a hard connection to the breakers to trip quickly should there be a problem inside the equipment.

In the pool water, always test to confirm there are very low levels of voltage (<2 mV) and current (<2 μA) between the water and the rail support handles or anything else a person might touch while entering the pool. Making the pool water the same voltage as the electric grid is not a sound solution towards preventing harm. An equipotential grid still has current running through it. And, under fault conditions, the current and voltage conditions in an equipotential plane will exceed an acceptable NEC fire code standard. The principal of reducing the voltage difference between two points with bonding to achieve a healthy standard has been shown to be a faulty premise in Equipotential Planes, a Figment of the Imagination by Forensic Electrical Engineer Donald W. Zipse. [ieeexplore.ieee.org/document/1677287]

Zipse: “If the public wants to be able to enter a swimming pool or a hot tub or to take a shower without the fear of receiving an unwanted electric shock or to be a victim of an electrocution, then the public must rise up in letter writing to their Public Service Commissions and their legislators both local and federal and demand an electrical distribution system free from to flow of uncontrolled hazardous stray current.” [ieeexplore.ieee.org/document/1242596]

GEC 1/0 to Compensate for the Change in Grounding

Oversizing the Grounding Electrode Conductor (GEC) may be essential after installing the NCB because the NCB will remove parallel paths to earth. The service neutral is struggling to begin with and is one of the biggest reasons inspiring the need for the NCB invention in the first place. The Neutral cannot handle all the harmonics and loads so that over-current is being pushed into the earth and our grounding system. If we remove these multiple paths to earth, the pressure will be concentrated back on the neutral conductor and back up into the home grounding system and that could mean higher electric and/or magnetic fields throughout the home. Oversizing the GEC helps relieve this pressure on the home equipment grounding conductor system. This has been proven, before and after, with a NFA 1000 9-point bed map diagnostic. [homeemftracing.com/shop/ols/products/10-gec-confirmation-nfa-9-point]

It is also essential to establish only one neutral-to-earth connection per residence, at the meter, and not at the main distribution breaker panel. Ensuring a meter/disconnect combo has no appliance breakers in that panel will reduce the amount of “foreign” primary return current circulating through the home wiring. [homeemftracing.com/shop/ols/products/meter-disconnect-installation-notes]

After the electrician removes all the code violations that put current onto the equipment grounding conductors, the NCB can be used to remove the remaining current.

What is claimed is:

1. A current blocking device that prevents low level current from entering a home or an electrical circuit or a grounded object; enables fault level voltages and current to pass quickly in order to effectively activate overcurrent protection devices.

2. The current blocking device of claim 1 can be used to block “foreign” current sources like NEV or stray voltage, sourced from primary side transformer grid current where no protection in homes exists at this time.

3. The current blocking device of claim 1 further comprising a choke/inductor that helps trap 3 kHz and above frequencies from entering the home on the grounding conductor circuit.

4. The current blocking device of claim 1 wherein the device is positioned to isolate certain bonds or appliance parts so current loops eliminated, yet preserves fault protection.

5. The current blocking device of claim 1 is used to reduce electric field charge build up by draining away excessive capacitive voltages from conductive materials and objects.

6. The current blocking device of claim 1 is used to provide a healthier environment by preventing harmful contact current exposures from shielded walls, grounding mats and other grounded objects and surfaces.

7. The current blocking device of claim 1 reduces magnetic fields from current flows on grounding systems.
